(19) United States
(12) Patent Application Publication
(10) Pub. No.: US 2005/0077710 A1
(43) Pub. Date: Apr. 14, 2005

(54) Device for occupant classification and method for ocuupant classification

(76) Inventors: Martin Schmied, Neckarweihingen (DE); Frank Mack, Stuttgart (DE)

Correspondence Address: KENYON & KENYON, ONE BROADWAY, NEW YORK, NY, 10004, US

(21) Appl. No.: 10/499,889

(22) PCT Filed: Nov. 5, 2002
(86) PCT No.: PCT/DE02/04095

(30) Foreign Application Priority Data
Dec. 22, 2001 (DE) 101 63 910.4

(51) Int. Cl. B60R 21/32

(52) U.S. Cl. 280/735

(57) ABSTRACT

A device and method for passenger classification in a vehicle are provided. A region of vehicle entry is monitored by an imaging sensor and passenger classification is performed as a function of the imaging sensor signals. This passenger classification may be refined by signals from a seatbelt buckle, door switch sensor, and/or a passenger compartment sensor.

### FIELD OF THE INVENTION

The present invention relates to a device as well as a method for passenger classification.

### BACKGROUND INFORMATION

According to American regulation FMVSS208, future airbag generations are to deactivate or activate airbags as a function of a person, a child, or a child seat. This will require systems capable of differentiating between adult persons in the passenger seat and a child seat.

### SUMMARY OF THE INVENTION

According to an exemplary embodiment of the present invention, this is performed by sensing or recording of the entry operation, thereby enabling differentiation between child seats and adult persons completely independent of the position of the person or the child seat. The passenger classification is independent of the use of booster seats, seat back inclination, seat cushion adjustment, and seat cushion inclination, and the aging processes of the seat also have no effect.

In an exemplary embodiment of the present invention the imaging sensor is configured as a video and/or ultrasound and/or infrared and/or microwave sensor. Combinations of these different technologies may also be used. In this context, every sensor has a transmitting and a receiving device.

In an exemplary embodiment of the present invention the monitored region is divided into at least two zones that are each monitored by the imaging sensor. For this purpose, the imaging sensor may include different sensor elements or corresponding optic systems that allow monitoring of the different zones. Zone formation allows in particular the determination of the time-based sequence of a movement. As a result, it is possible to determine whether an object is entering or exiting the vehicle. If, for example, first zone 1, then zones 1 and 2, and finally only zone 2 are penetrated, an object entered the vehicle. An additional zone in the transverse vehicle direction facilitates during opening of the doors determination of whether something is already located on the vehicle seat in order to subsequently detect from the entering or exiting operations whether the object is a person. Furthermore, additional zones in the longitudinal vehicle direction may be monitored to encompass the inner door handle, for example.

In an exemplary embodiment of the present invention the processor is connectable with a door switch and/or a seatbelt buckle and/or a passenger compartment sensor, and signals from these objects are also used for passenger classification. In this context, a sensor signal from the door switch is used to determine whether the door is open or closed, from the seatbelt buckle to determine whether the seatbelt is buckled, and from the passenger compartment sensor to determine which persons or objects were detected on a vehicle seat.

In an exemplary embodiment of the present invention the imaging sensor is positioned in the A and/or the B pillar and/or the doorsill. In the case of doorsills, this position may be at the top or the bottom.

In an exemplary embodiment of the present invention the passenger compartment sensor may be configured as a seat mat and/or as an additional imaging sensor aligned toward a vehicle seat.

In an exemplary embodiment of the present invention the first imaging sensor may be positioned in a horizontal as well vertical direction or in a combination thereof. A combination in a vertical and horizontal direction has the particular advantage of improved monitoring of the region of vehicle entry.

In an exemplary embodiment of the present invention a movement direction of an object in the region of vehicle entry or a distance of the object from the first sensor is derived from the signal of the first imaging sensor. This may also occur in connection with further data, such as whether a vehicle is closed or open, how long the vehicle door has been open or closed, or when a seatbelt buckle was buckled, in that this data set is compared with different scenario data sets in order to determine whether a person or an object is located on the vehicle seat, e.g., the passenger seat.

### BRIEF DESCRIPTION OF THE DRAWINGS

FIG. 1 is a block diagram of the device of an exemplary embodiment of the present invention.

FIGS. 2a and 2b show a schematic transverse vehicle view and a longitudinal vehicle view, respectively, showing different zones in the region of vehicle entry.

FIG. 3 is a flow chart of an exemplary method of the present invention.

### DETAILED DESCRIPTION

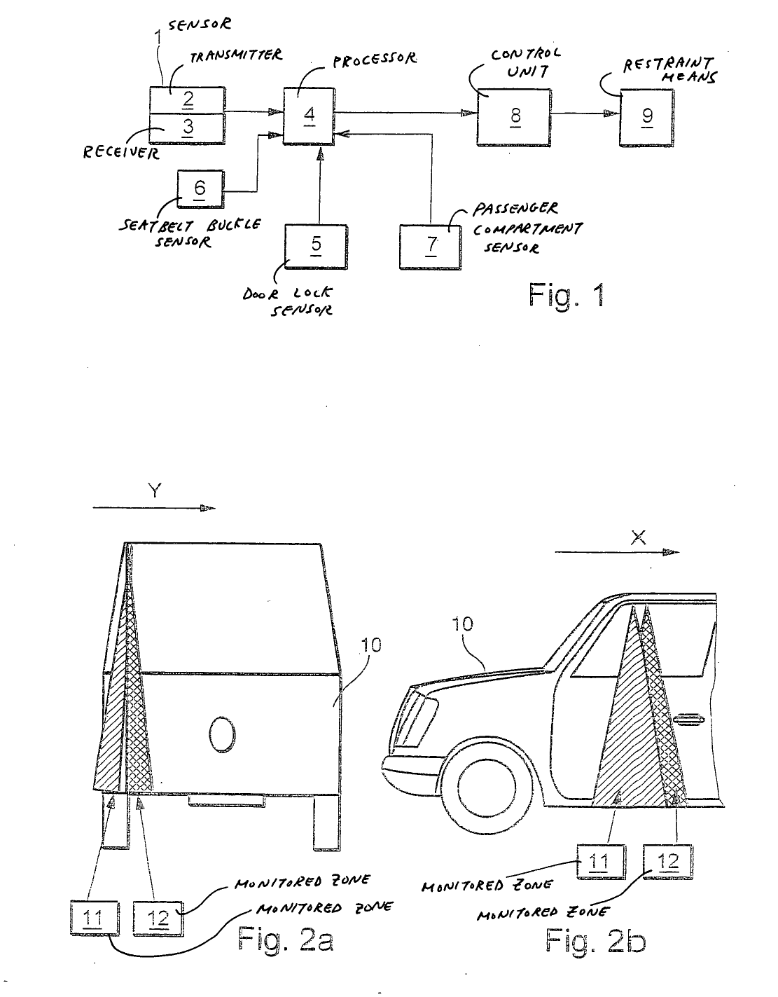

FIG. 1 shows a block diagram of an exemplary embodiment of the device of the present invention. An imaging sensor, for example an ultrasound sensor, includes a transmitter 2 and a receiver 3. Sensor 1 is attached in this case to the top of the doorsill. As shown in FIG. 2b, sensor 1 scans two zones 11 and 12. Alternatively, additional zones also situated in the longitudinal vehicle direction are possible here, or may also be situated in the transverse vehicle direction as shown in FIG. 2a. In addition to a combination of a transmitter 2 and receiver 3, entire fields of such sensors are also possible, however with a minimum of two for monitoring the different zones independently of one another. Alternatively, it is possible for an imaging sensor to include an optical system that enables consecutive, i.e., cyclical, scanning of the different zones. In addition to the already mentioned ultrasound sensor, microwave sensors having a low output and representing a type of radar, infrared sensors, and video sensors are also possible.

The output signal of the ultrasound sensor generated by receiver 3, is transmitted to a processor 4, which calculates from the received signal of receiver 3 whether an object is located in the zones. Processor 4 is also able to calculate the movement direction from the crossing of the zones and the distances of the person from the sensor. As a result, a minimum size of the person is able to be estimated, for example. Sensor 4 also evaluates signals from a seatbelt buckle sensor 6, a door lock sensor 5, and a passenger compartment sensor 7. Processor 4 uses these signals to perform the passenger classification. It is possible to dispense with seatbelt buckle sensor 6 and/or door lock sensor 5 and/or passenger compartment sensor 7. The signals from sensor 1 and sensors 5, 6, and 7 make it possible to form a data set that matches a specific scenario for the occupation of the vehicle seat. The resulting passenger classification is transmitted to a control unit 8 that then controls restraint means 9 as a function of this passenger classification. Transmission between processor 4 and control unit 8 may be performed via a bus, but it is also possible to use a digital interface here. In addition to control unit 8 for the restraint means, it is also possible to provide data from processor 4 to additional control units that may benefit from the passenger classification.

FIGS. 2a and 2b show such different zones covered by sensor 1 as already described above. In FIG. 2a, such zones are described in the transverse vehicle direction, designated as Y in this case. Vehicle 10 has two zones 11 and 12, which the object and/or person must penetrate to enter the vehicle. In FIG. 2b, vehicle 10 has two zones also designated by reference numerals 11 and 12 in the longitudinal vehicle direction designated here as X. This allows improved coverage of the vehicle entry cross section.

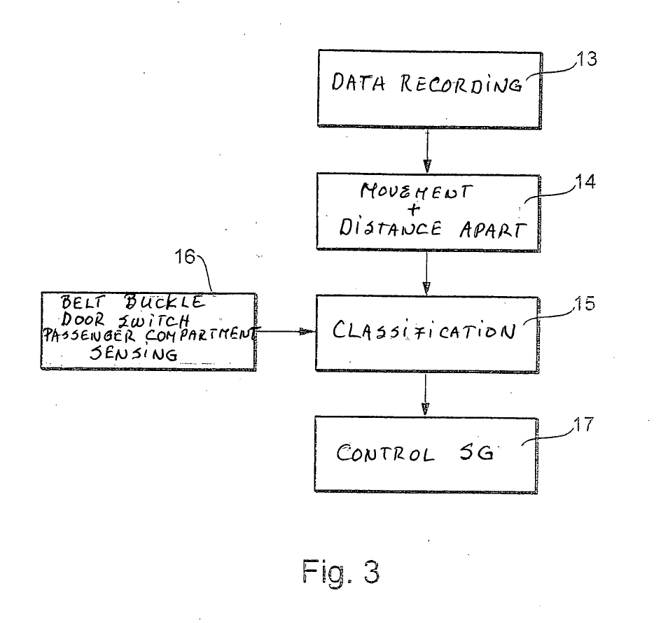

FIG. 3 is a flow chart illustrating the method of the present invention for passenger classification. The data acquisition of sensor 1 is performed in method step 13. This data is transmitted to processor 4 as described above. Processor 4 uses this data in method step 14 to calculate the movement of the object and the distance from the sensors. As a result, a scenario is able to be established for specific situations. In method step 15, the classification is performed by processor 4, which takes data from the seatbelt buckle sensor and/or door switch (door lock) sensor and/or the passenger compartment sensor from method step 16 into consideration. The thus determined classification is then transmitted in method step 17 to control unit 8, which then controls restraint means 9.

Several examples as to how the evaluation logic may function for a system having two zones in the Y direction are listed in the following.

TABLE 1
System having two zones in the Y direction: Time
history of activation for an entry operation (0: no
activation; 1: activation).

| Time | Zone 1 | Zone 2 | Result |
|---|---|---|---|
| t1 | 0 | 0 | |
| t2 | 1 | 0 | |
| t3 | 1 | 1 | |
| t4 | 0 | 1 | Entry operation -> Person |
| t5 | 0 | 0 | Entry operation -> Person |

TABLE 2
System having two zones in the Y direction: Time
history of activation for an exit operation (0: no activation;
1: activation).

| Time | Zone 1 | Zone 2 | Result |
|---|---|---|---|
| t1 | 0 | 0 | |
| t2 | 0 | 1 | |
| t3 | 1 | 1 | |
| t4 | 1 | 0 | Exit operation -> Person |
| t5 | 0 | 0 | Exit operation -> Person |

TABLE 3
System having two zones in the Y direction: Time
history of activation when placing a child in a child seat or
when assembling a child seat no activation; 1: activation).

| Time | Zone 1 | Zone 2 | Result |
|---|---|---|---|
| t1 | 0 | 0 | |
| t2 | 1 | 0 | |
| t3 | 1 | 1 | |
| t4 | 1 | 0 | Bending in -> Child seat |
| t5 | 0 | 0 | Bending in -> Child seat |

Additional tables describing a system having two zones in the Y direction in combination with information regarding the door lock and seatbelt buckle are provided in the following.

TABLE 4
System having two zones in the Y direction: Time
history of activation for a possible entry operation (0: no
activation; 1: activation).

| | | | Door | Seatbelt | |
|---|---|---|---|---|---|
| Time | Zone 1 | Zone 2 | open | buckled | Result |
| t1 | 0 | 0 | 0 | 0 | |
| t2 | 0 | 0 | 1 | 0 | |
| t3 | 1 | 0 | 1 | 0 | |
| t4 | 1 | 1 | 1 | 0 | |
| t5 | 0 | 1 | 1 | 0 | |
| t6 | 0 | 0 | 1 | 0 | Entry operation -> |
| | | | | | Person |
| t7 | 0 | 0 | 0 | 0 | Entry operation -> |
| | | | | | Person |
| t8 | 0 | 0 | 0 | 1 | Entry operation -> |
| | | | | | Person |

TABLE 5
System having two zones in the Y direction: Time
history of activation for a possible exit operation (0: no
activation; 1: activation).

| | | | Door | Seatbelt | |
|---|---|---|---|---|---|
| Time | Zone 1 | Zone 2 | open | buckled | Result |
| t1 | 0 | 0 | 0 | 1 | |
| t2 | 0 | 0 | 0 | 0 | |
| t3 | 0 | 0 | 1 | 0 | |
| t4 | 0 | 1 | 1 | 0 | |
| t5 | 1 | 1 | 1 | 0 | |
| t6 | 1 | 0 | 1 | 0 | Exit operation -> |
| | | | | | Person |
| t7 | 0 | 0 | 1 | 0 | Exit operation -> |
| | | | | | Person |
| t8 | 0 | 0 | 0 | 0 | Exit operation -> |
| | | | | | Person |

TABLE 6
System having two zones in the Y direction: Time
history of activation when placing a child in a child seat or
when assembling a child seat (0: no activation; 1:
activation).

| | | | Door | Seatbelt | |
|---|---|---|---|---|---|
| Time | Zone 1 | Zone 2 | open | buckled | Result |
| t1 | 0 | 0 | 0 | 0 | |
| t2 | 0 | 0 | 1 | 0 | |
| t3 | 1 | 0 | 1 | 0 | |
| t4 | 1 | 1 | 1 | 0 | |
| t5 | 1 | 1 | 1 | 1 | |
| t6 | 1 | 0 | 1 | 1 | Bending in -> |
| | | | | | Child seat |
| t7 | 0 | 0 | 1 | 1 | Bending in -> |
| | | | | | Child seat |
| t8 | 0 | 0 | 0 | 1 | Bending in -> |
| | | | | | Child seat |

1-14. (canceled)

15. A device for classifying a passenger in a vehicle, comprising:
a first imaging sensor positioned in a region of vehicle entry and monitoring said region of vehicle entry; and
a processor connected to the first imaging sensor for performing a passenger classification based on information from said first imaging sensor.

16. The device of claim 15, wherein the first imaging sensor is configured as at least one of a video sensor, ultrasound sensor, infrared sensor and microwave sensor.

17. The device of claim 16, wherein the region of vehicle entry is divided into at least two zones, each of the at least two zones being monitored by the first imaging sensor.

18. The device of claim 15, wherein the processor communicates with a door switch, and a signal from the door switch is taken into consideration by the processor in the passenger classification.

19. The device of claim 15, wherein the first imaging sensor is situated in at least one of an A pillar, a B pillar and a doorsill of the vehicle.

20. The device of claim 15, wherein the processor communicates with a seatbelt buckle sensor, and a signal from the seatbelt buckle sensor is taken into consideration by the processor in the passenger classification.

21. The device of claim 15, wherein the processor communicates with a passenger compartment sensor, and a signal from the passenger compartment sensor is taken into consideration by the processor in the passenger classification.

22. The device of claim 21, wherein the passenger compartment sensor is configured as at least one of a seat mat and a second imaging sensor aligned toward a vehicle seat.

23. The device of claim 15, wherein the first imaging sensor is positioned in at least one of a vertical and horizontal direction.

24. A method for classifying a passenger in a vehicle, comprising:
monitoring a region of vehicle entry, using a first imaging sensor situated in the region of vehicle entry; and
performing a passenger classification based on a signal of the first imaging sensor.

25. The method of claim 24, further comprising:
deriving, from the signal of the first imaging sensor, a movement direction of at least one of an object in the region of vehicle entry and an object at a distance from the first imaging sensor.

26. The method of claim 24, wherein at least one of a signal from a door switch, a signal from a seatbelt buckle sensor and a signal from a passenger compartment sensor is taken into consideration by the processor in the passenger classification.

27. The method of claim 26, further comprising:
using the signal from the door switch to determine at least one of: a) whether a vehicle door is closed or open; and b) how long the vehicle door has been opened or closed.

28. The method of claim 26, further comprising:
using the signal from the seatbelt buckle to determine at least one of: a) whether the seatbelt buckle is buckled; and b) when the seatbelt buckle was buckled.
